(19) United States
(12) Patent Application Publication
(10) Pub. No.: US 2008/0001881 A1
(43) Pub. Date: Jan. 3, 2008

(54) LIQUID CRYSTAL DISPLAY AND IMAGE DISPLAY METHOD

(75) Inventors: Masahiro Baba, Yokohama-shi (JP); Goh Itoh, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/767,618

(22) Filed: Jun. 25, 2007

(30) Foreign Application Priority Data
Jun. 30, 2006 (JP) 2006-181745

(51) Int. Cl. G09G 3/36

(52) U.S. Cl. 345/89

(57) ABSTRACT

There is provided with an image display method including: calculating black information indicating a length of a period in which a black image should be displayed in one frame period of an input image or a ratio of a period in which the black image should be displayed in the one frame period of the input image; controlling a light source luminance of the light source according to the information to suppress fluctuation of a display luminance at a maximum gray-scale level displayable by a liquid crystal panel due to variation of a length of a black display period depending on the information; correcting a gray-scale level of each pixel of the input image to obtain corrected gray-scale levels for suppressing fluctuation of a display luminance at gray-scale levels other than the maximum gray-scale level due to the control of the light source luminance of the light source.

### CROSS-REFERENCE TO RELATED APPLICATIONS

This application is based upon and claims the benefit of priority from the prior Japanese Patent Applications No. 2006-181745 filed on Jun. 30, 2006, the entire contents of which are incorporated herein by reference.

### BACKGROUND OF THE INVENTION

1. Field of the Invention

The present invention relates to a liquid crystal display and an image display method for improving qualities of moving image and still images while suppressing an increase in power consumption.

2. Related Art

When a moving image is displayed on a liquid crystal display or an organic EL (electroluminescence) display, the image looks blurred. This problem occurs because a temporal characteristic of an image display method of the liquid crystal display and the organic EL display is different from that of a cathode ray tube (hereinafter referred to as CRT).

The liquid crystal display and the organic EL display adopt a display method with which a displayed image is held for a period of one frame (hereinafter referred to as hold-type display). On the other hand, the CRT adopts a display method with which each of pixels emits for a short time and then darkened (hereinafter referred to as impulse-type display).

In the case of the hold-type display, in a period from the time when an Nth frame in the moving image is displayed until the next N+1th frame is displayed, the same image as the Nth frame is displayed. When a moving object is shown in the input image, the moving object remains stationary on a screen in the period from the time when the Nth frame is displayed until the N+1th frame is displayed. Therefore, The moving object moves discontinuously when the N+1th frame is displayed.

On the other hand, when an observer focuses on the moving object and tracks it (when an eye movement of the observer is a pursuit eye movement), the observer tries to move the eyes and pursues the moving object continuously and smoothly.

Then, a difference occurs between a motion of the moving object on the screen and a motion of the moving object assumed by the observer. Because of this difference, images shifted depending on speed of the moving object are presented on retinas of the observer. Therefore, the observer receives an impression that a moving image is blurred.

As the moving object moves at higher speed, since the shift of images presented on the retina of the observer increases, the observer receives an impression that the moving image is more blurred.

Such “blurring” does not occur in the case of the impulse-type display. This is because black image is displayed between frames of the moving image (e.g., between the Nth frame and the N+1th frame described above) in the case of the impulse-type display.

Since black image is displayed between frames, even when the observer is moving the eyes to smoothly pursue the moving object, the observer cannot see images except instances when images are displayed. Since the observer recognizes frames of the moving image as images independent from one another, images presented on the retinas are not shifted.

In order to solve the problems described above in the hold-type display, a method of displaying “black” by some means after displaying a frame is proposed (see, for example, JP-A H11-109921 (Kokai)).

There is also proposed a method of detecting whether an input image is a moving image or a still image and displaying black image between temporal two frames only in the case that the input image is the moving image (see, for example, JP-A 2002-123223 (Kokai)).

In JP-A H11-109921 (Kokai), a screen of liquid crystal is intentionally turned into black image between frames like the impulse-type display and control deterioration in a quality of a moving image. However, power consumption of a backlight that emits even during a black display period is wasted. Moreover, in a still image, there is a problem in that flicker due to the impulse-type display occurs.

In JP-A 2002-123223 (Kokai), in order to solve the problems described above, display is controlled to be the hold-type display during the still image display and to be the impulse-type display during the moving image display. During the still image display, display same as that of the normal liquid crystal display is performed. During the moving image display, “black” is displayed between frames to perform the impulse-type display. In that case, display luminance of the liquid crystal display decreases because “black” is displayed between frames. Therefore, fluctuation in luminance during the hold-type display and during the impulse-type display is controlled by increasing the luminance of the backlight during the impulse-type display and reducing the luminance of the backlight during the hold-type display. However, when fluctuation in display luminance is controlled only by adjusting the luminance of the backlight as described above, for example, it is possible to control fluctuation in display luminance in displaying a white image of maximum gray-scale level. However, in that case, fluctuation in luminance of a middle gray-scale level is not sufficiently controlled. This is because, even when the transmittance of a liquid crystal panel is minimized (0 gray-scale level), a part of the light from the backlight transmits in the liquid crystal panel. Displaying the 0 gray-scale level is equivalent to displaying “black”. Therefore, when an input image is a black image, the transmittance of the liquid crystal panel is the same in both the impulse-type display and the hold-type display. However, since the luminance of the backlight is set high in the impulse-type display compared with the hold-type display, the luminance changes in the impulse-type display and the hold-type display due to the leak of light. Since the phenomenon described above also occurs in the middle gray-scale level, display luminance of the middle gray-scale level changes in the impulse-type display and the hold-type display.

### SUMMARY OF THE INVENTION

According to an aspect of the present invention, there is provided with a liquid crystal display which comprises an input unit, a light source, a liquid crystal panel, a black information calculator, a light-source-luminance controller, a gray-scale level corrector and a liquid crystal panel driver. The input unit is configured to input an input image. The light source is configured to emit light. The liquid crystal panel is configured to display an image by modulating a transmittance or a reflectance of light from the light source based on signals representing the image. The black information calculator is configured to calculate black information indicating a length of a period in which black should be displayed in one frame period of the input image or a ratio of a period in which black should be displayed in the one frame period of the input image. The light-source-luminance controller is configured to control a light source luminance of the light source according to the black information to suppress fluctuation of a display luminance at a maximum gray-scale level displayable by the liquid crystal panel due to variation of a length of a black display period depending on the black information. The gray-scale level corrector is configured to correct a gray-scale level of each pixel of the input image to obtain corrected gray-scale levels to suppress fluctuation of a display luminance at gray-scale levels other than the maximum gray-scale level due to controlling of the light source luminance of the light source. The liquid crystal panel driver is configured to, in the one frame period, (1) provide the liquid crystal panel with signals of each pixel having the corrected gray-scale levels in continuous period obtained by subtracting a black display period depending on the black information from the one frame period, and (2) provide the liquid crystal panel with signals of each pixel indicating black in the black display period.

According to an aspect of the present invention, there is provided with an image display method for performing in an image display device including a light source capable of adjusting a light source luminance and a liquid crystal panel displaying an image by modulating a transmittance or a reflectance of light from the light source based on signals representing the image. The image display method comprises steps of inputting an input image, calculating black information, controlling a light source luminance of the light source, correcting a gray-scale level of each pixel of the input image, providing the liquid crystal panel with signals of each pixel having the corrected gray-scale levels and providing the liquid crystal panel with signals of each pixel indicating black. The black information indicates a length of a period in which a black image should be displayed in one frame period of an input image or a ratio of a period in which the black image should be displayed in the one frame period of the input image. The light source luminance of the light source is controlled according to the black information to suppress fluctuation of a display luminance at a maximum gray-scale level displayable by the liquid crystal panel due to variation of a length of a black display period depending on the black information. The gray-scale level of each pixel of the input image is corrected to obtain corrected gray-scale levels to suppress fluctuation of a display luminance at gray-scale levels other than the maximum gray-scale level due to the controlling of the light source luminance of the light source. The signals of each pixel having the corrected gray-scale levels is provided in continuous period obtained by subtracting a black display period depending on the black information from the one frame period. The signals of each pixel indicating black are provided in the black display period.

### BRIEF DESCRIPTION OF THE DRAWINGS

FIG. 1 is a block diagram showing a structure of a liquid crystal display according to a first embodiment;

FIG. 2 is a diagram for explaining a black insertion ratio;

FIG. 3 is a diagram showing a lookup table in which input gray-scale levels and corrected gray-scale levels according to the black insertion ratio are held;

FIG. 4 is a graph showing a relation between an input gray-scale level and a relative luminance for each black insertion ratio;

FIG. 5 is a graph for explaining an effect of the first embodiment;

FIG. 6 is a graph for explaining an effect of the first embodiment;

FIG. 7 is a diagram showing another example of the lookup table;

FIG. 8 is a diagram showing an example of a structure of a liquid crystal panel;

FIG. 9 is a timing chart of a liquid crystal display panel;

FIG. 10 is a diagram showing examples of display states of the liquid crystal panel;

FIG. 11 is a diagram showing a relation among a black insertion ratio, a relative transmittance of a liquid crystal panel, a relative luminance of backlight, and a relative luminance of a liquid crystal display;

FIG. 12 is a diagram for explaining a method of detecting a motion vector;

FIG. 13 is a diagram showing an example of a lookup table in a second embodiment;

FIG. 14 is a diagram for explaining an effect of the second embodiment;

FIG. 15 is a diagram showing another example of a lookup table in the second embodiment; and

FIG. 16 is a flowchart for explaining an image display method executed in the liquid crystal display in FIG. 1.

### DETAILED DESCRIPTION OF THE INVENTION

### First Embodiment

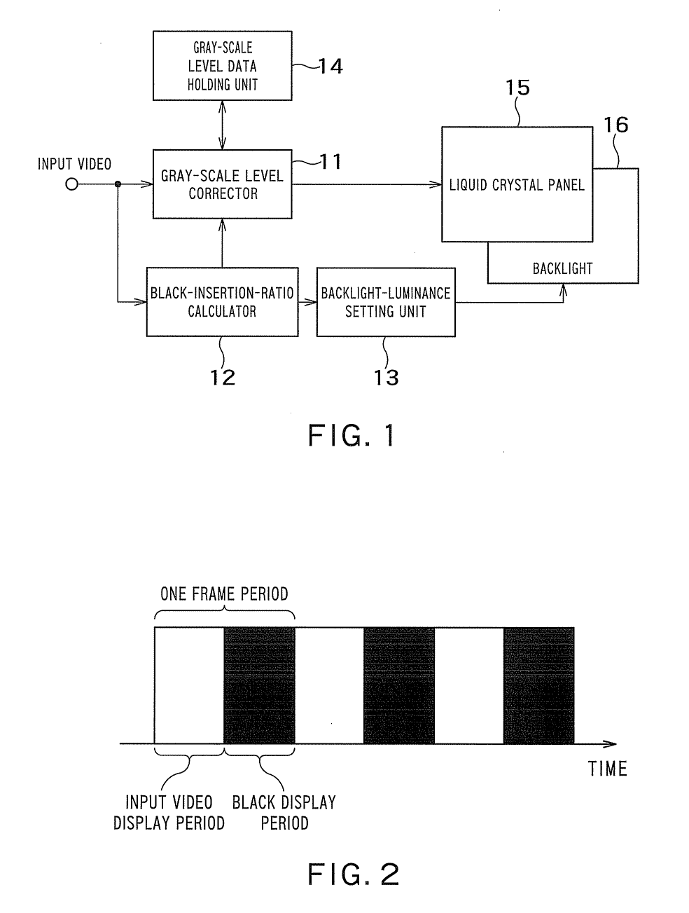

A structure of a liquid crystal display according to a first embodiment of the invention is shown in FIG. 1. An input video (an input image) is inputted to a gray-scale level corrector 11 and a black-insertion-ratio calculator (a black information calculator) 12. The black-insertion-ratio calculator 12 calculates, according to the input video, a black insertion ratio (black information), which is a ratio of a black display period between frames of the input video displayed on a liquid crystal panel 15 to one frame period, and sends the black insertion ratio to the gray-scale level corrector 11 and a backlight-luminance setting unit (a light-source-luminance controller) 13. The gray-scale level corrector 11 converts gray-scale levels of respective pixels of the input video into corrected gray-scale levels with reference to a lookup table held in a gray-scale level-correction-data holding unit (memory) 14 based on the black insertion ratio and an input gray-scale level. A corrected video converted into the corrected gray-scale levels is inputted to the liquid crystal panel 15 together with control signals (a horizontal synchronizing signal, a vertical synchronizing signal, etc.) depending on the black insertion ratio for driving the liquid crystal panel 15. The liquid crystal panel 15 displays the corrected video inserted the black display period between frames by using the input control signals. The backlight-luminance setting unit 13 calculates a backlight luminance on the basis of the black insertion ratio inputted from the black-insertion-ratio calculator 12 and sends the backlight luminance to a backlight 16. The backlight 16 emits light at the backlight luminance set by the backlight-luminance setting unit 13 at timing when the corrected image is displayed on the liquid crystal panel 15.

Operations of the respective parts will be hereinafter explained in detail.

### (Black-Insertion-Ratio Calculator)

The black-insertion-ratio calculator 12 calculates a black insertion ratio on the basis of an input video. The black insertion ratio is, as shown in FIG. 2, a ratio of the black display period to one frame period. As a basic operation, when the input video is a moving image, the black insertion ratio is increased and, when the input video is a still image, the black insertion ratio is reduced. In other words, the black-insertion-ratio calculator 12 detects whether the input video is a moving image or a still image and calculates the black insertion ratio. Various methods are conceivable as a method of detecting a moving image and a still image. In this embodiment, a method described below is used.

In a method of detecting a moving image and a still image according to this embodiment, an input video is held in a frame memory for one frame period and a moving image and a still image are detected using an image delayed by one frame and the input image, i.e., two frames temporally adjacent to each other. Images for detecting a moving image and a still image are not limited to the temporally adjacent two frames. For example, when the input video is an interlaced video, detection of a moving image and a still image may be performed using only even fields or odd fields. Moreover, a sum of absolute difference between two frames is calculated and threshold processing is applied to the sum of absolute difference to detect whether the input video is a moving image or a still image. When the sum of absolute difference is equal to or larger than a predetermined threshold, it is detected that the input video is a moving image. When the sum of absolute difference is smaller than the predetermined threshold, it is detected that the input video is a still image. A sum of absolute difference of an Nth frame and an N+1th frame with the number of horizontal pixels X and the number of vertical pixels Y is represented by Equation 1.

$$SAD = {\sum }_{u = 1}^{X} {\sum }_{v = 1}^{Y} \vert f ( u , v , N ) - f ( u , v , N + 1 ) \vert \qquad [ Equation 1 ]$$

where, SAD represents the sum of absolute difference and f(u, v, N) represents a Y value of a pixel in a position (u, v) of an Nth frame. f(u, v, N) is represented as a linear sum of pixel values (gray-scale levels) of red, green, and blue as indicated by Equation 2.

f(u,v,N)=0.299R(u,v,N)+0.587G(u,v,N)+0.114B(u,v,N) [Equation 2]

R(u, v, N), G(u, v, N), and B(u, v, N) represent pixel values of red, green, and blue in a position (u, v) of an Nth frame, respectively. In this embodiment, the sum of absolute difference of a Y value is calculated. However, sum of absolute differences of pixel values of red, green, and blue may be calculated respectively.

In this embodiment, the sum of absolute difference is calculated for all the pixels in one frame. However, to simplify processing, the sum of absolute difference may be calculated for discrete pixels or one frame may be down-sampled, and then calculate the sum of absolute difference for the down-sampled image.

Moreover, a sum of absolute difference between frames may be calculated for every two frames or every plural frames other than between adjacent frames.

To make operations more robust, a method of detecting motion information of a present frame using motion information of several frames in the past may be used. For example, the motion information of a still image is represented as 0 and that of a moving image is represented as 1, median processing is performed from motion information of five frames in the past, and motion information of the median is set as a result of detection of a moving image and a still image of a present frame. By performing such processing, even if a moving image is detected only for a certain frame because of a failure in detection of a moving image and a still image in the present frame, a result of detection of a moving image and a still image indicates a still image according to the median processing.

As another method of detecting a moving image and a still image, an EPG (Electronic Program Guide) may be used. When a genre of a broadcast program is detected by the EPG and the broadcast program includes a large number of moving images such as a sport program, it is detected that an input video is a moving image. When the broadcast program includes a large number of still images such as a news program, it is detected that the input video is a still image.

It is detected as described above whether the input video is a moving image or a still image and a black insertion ratio is calculated within a predetermined black insertion ratio range. For example, when the black insertion ratio range is a range from 0% to 50%, a black insertion ratio is set to 0% in the case of a still image and is set to 50% in the case of a moving image. The calculated black insertion ratio is sent to the backlight-luminance setting unit 13 and the gray-scale level corrector 11.

### (Gray-Scale Level Corrector)

The gray-scale level corrector corrects gray-scale levels of respective pixels of the input video on the basis of the black insertion ratio calculated by the black-insertion-ratio calculator. A relation between an input gray-scale level and a corrected gray-scale level for each black insertion ratio is held in a gray-scale level correction data holding unit (a memory) described later. The gray-scale level corrector calculates a corrected gray-scale level with reference to the gray-scale level correction data holding unit according to the black insertion ratio calculated by the black-insertion-ratio calculator and the gray-scale levels of the respective pixels of the input video. The corrected video converted the input gray-scale level into the corrected gray-scale level is sent to the liquid crystal panel together with control signals such as a vertical synchronizing signal, a horizontal synchronizing signal, and the like.

### (Gray-Scale Level Correction Data Holding Unit)

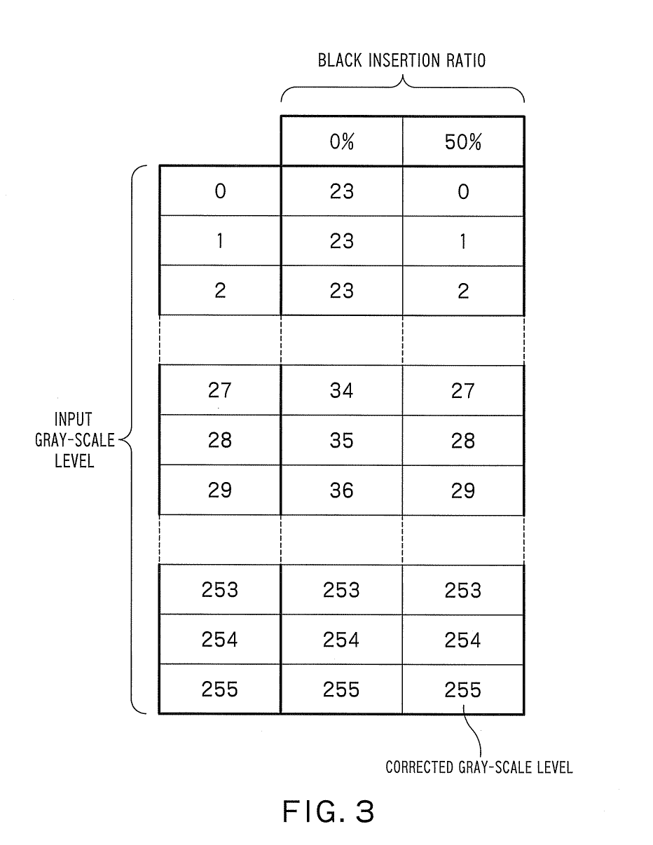

A relation between an input gray-scale level and a corrected gray-scale level for each black insertion ratio is held in the gray-scale level correction data holding unit 14 as an LUT (Look-up Table). The gray-scale level correction data holding unit 14 may have any structure as long as it is possible to hold the LUT. The gray-scale level correction data holding unit 14 is constituted by a ROM (Read Only Memory), a RAM (Random Access Memory), or the like. As a structure of the LUT, as shown in FIG. 3, when a black insertion ratio is calculated by the black-insertion-ratio calculator 12 as 0% or 50%, an LUT having a two-dimensional matrix structure with a black insertion ratio set in a column direction and an input gray-scale level set in a row direction is prepared. A column is selected according to the black insertion ratio and a row is selected according to the input gray-scale level. A value of an intersection of the column and the row is outputted as a corrected gray-scale level. The LUT described above is an example. The LUT may take any structure as long as it is possible to output a corrected gray-scale level from a black insertion ratio and an input gray-scale level.

Correction data held in the gray-scale level correction data holding unit 14 will be hereinafter explained in detail.

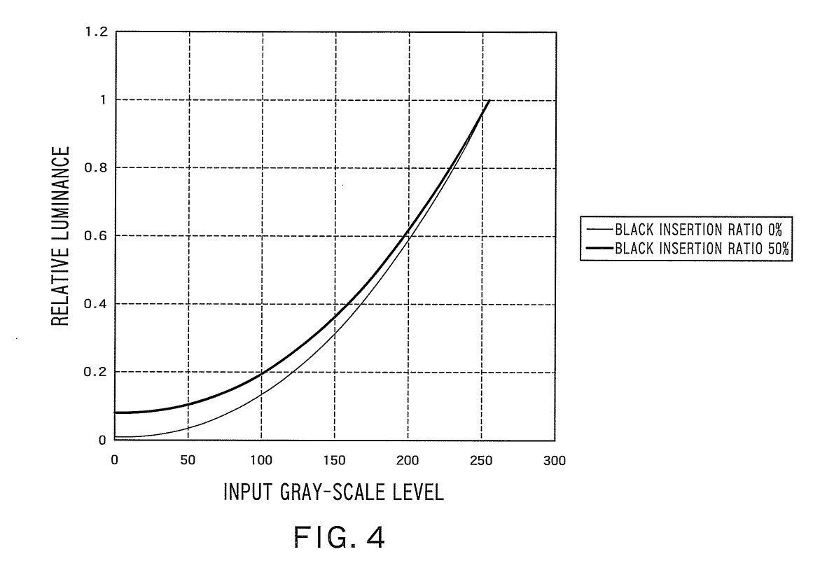

A relation between an input gray-scale level displayed on the liquid crystal display and a relative luminance (a display gamma characteristic) depending on a black insertion ratio is shown in FIG. 4. The backlight luminance is controlled, so as to maintain a constant display luminance (1 in FIG. 4) without depending on the black insertion ratios (0% and 50%) in the case that 255 gray-scale level (maximum gray-scale level in a liquid crystal display capable of representing 8 bits) is displayed on the liquid crystal display.

However, even if the display luminance in the 255 gray-scale level is constant as described above, when the black insertion ratios are different, brightness is different in gray-scale levels less than the 255 gray-scale level as shown in FIG. 4. A reason for this is described below.

A black insertion ratio is changed by changing the black display period between frames of an input video. When 0 gray-scale level is displayed on the liquid crystal display as an input gray-scale level, since the 0 gray-scale level is a black image, a transmittance of the liquid crystal panel does not change even if the black insertion ratio is changed. On the other hand, a backlight luminance is set different for the black insertion ratios 0% and 50% such that a display luminance does not change between the black insertion ratios 0% and 50% when the 255 gray-scale level is displayed on the liquid crystal display. Since the transmittance of the liquid crystal panel is different by about two times between the black insertion ratios 0% and 50%, the backlight luminance is also different by about two times between the black insertion ratios 0% and 50%. When the input gray-scale level is the 0 gray-scale level, regardless of the fact that the backlight luminance is different by about two times, the transmittance of the liquid crystal panel does not change. Therefore, the luminance of the liquid crystal display varies according to the difference of the backlight luminance. In the example explained here, the input gray-scale level is the 0 gray-scale level. However, the luminance of the liquid crystal display varies at all input gray-scale levels lower than the 255 gray-scale level depending on a black insertion ratio because of the same reason.

The gray-scale level correction data held by the gray-scale level correction data holding unit 14 is correction data for controlling this difference in brightness. As a correction method, there are two methods: a method of adjusting a display gamma characteristic at the minimum black insertion ratio (the black insertion ratio 0%) to a display gamma characteristic at the maximum black insertion ratio (the black insertion ratio 50%) and a method of adjusting a display gamma characteristic at the maximum black insertion ratio (the black insertion ratio 50%) to a display gamma characteristic at the minimum black insertion ratio (the black insertion ratio 0%).

(1) The method of adjusting a display gamma characteristic at the minimum black insertion ratio to a display gamma characteristic at the maximum black insertion ratio

A display gamma characteristic according to a black insertion ratio is represented by Equation 3.

$$I ( L , B ) = \frac{{( \frac{L}{255} )}^{γ} ( {T}_{max} ( 1 - B ) - {T}_{min} ) + {T}_{min}}{{T}_{max} ( 1 - B )} \qquad [ Equation 3 ]$$

where I(L, B) indicates a relative luminance of the liquid crystal display of an L gray-scale level at a black insertion ratio B, Tₘₐₓ indicates a maximum transmittance of the liquid crystal panel, Tₘᵢₙ indicates a minimum transmittance of the liquid crystal panel, B indicates a black insertion ratio, and γ indicates a gamma value. Equation 3 is an equation representing a display gamma characteristic when the maximum input gray-scale level is 255 gray-scale level. When an input gray-scale level is the 255 gray-scale level, a display luminance is fixed (or substantially fixed) by the backlight-luminance setting unit 13 described later without depending on a black insertion ratio. Therefore, in Equation 3, when L is 255, I(255, B) is represented as 1 without depending on any black insertion ratios. According to Equation 3, a display gamma characteristic in the case that the black insertion ratio is the maximum (the black insertion ratio 50%) is represented by Equation 4.

$${I}_{max} ( L ) = \frac{{( \frac{L}{255} )}^{γ} ( {T}_{max} ( 1 - {B}_{max} ) - {T}_{min} ) + {T}_{min}}{{T}_{max} ( 1 - {B}_{max} )} \qquad [ Equation 4 ]$$

where Iₘₐₓ(L) indicates a relative luminance of the liquid crystal display of an L gray-scale level at the maximum black insertion ratio and Bₘₐₓ indicates the maximum black insertion ratio. Therefore, a corrected gray-scale level for matching a display gamma characteristic at an arbitrary black insertion ratio B to a display gamma characteristic at the maximum black insertion ratio Bₘₐₓ is represented by Equation 5 from Equations 3 and 4.

$${L}_{c} ( L , B ) = 255 \cdot {( \frac{{I}_{max} ( L ) \cdot {T}_{max} ( 1 - B ) - {T}_{min}}{{T}_{max} ( 1 - B ) - {T}_{min}} )}^{1 / γ} \qquad [ Equation 5 ]$$

where L_{c}(L, B) represents a corrected gray-scale level at the time when an input gray-scale level is L and a black insertion ratio is B.

In this embodiment, the black insertion ratio is changed between 0% and 50%, and therefore, a display gamma characteristic at the black insertion ratio 50% is set to Iₘₐₓ(L) and a corrected gray-scale level at the black insertion ratio 0% is calculated by using Equation 5, whereby corrected gray-scale level data is obtained. This gray-scale level correction data is held in the LUT of the gray-scale level correction data holding unit 14.

Since the maximum black insertion ratio (the black insertion ratio 50%) is set as a reference, a corrected gray-scale level at the maximum black insertion ratio (the black insertion ratio 50%) coincides with an input gray-scale level. Therefore, it is unnecessary to hold the correction data of both the minimum black insertion ratio (the black insertion ratio 0%) and the maximum black insertion ratio (the black insertion ratio 50%) in the LUT as shown in FIG. 3. The gray-scale level corrector 11 may detect whether a black insertion ratio is the minimum or the maximum, and then, when the black insertion ratio is the maximum, directly output the input gray-scale level as a corrected gray-scale level, and, only when the black insertion ratio is the minimum, calculate a corrected gray-scale level with reference to the gray-scale level correction data holding unit 14. In this case, a relation between the input gray-scale level at the minimum black insertion ratio and the corrected gray-scale level only has to be held in the LUT of the gray-scale level correction data holding unit 14.

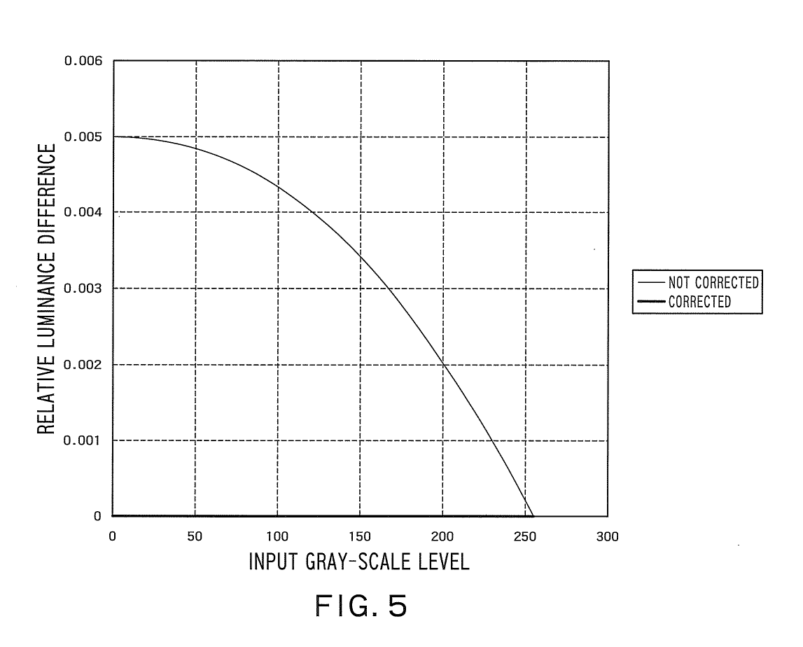

FIG. 5 shows a difference between a display gamma characteristic at the black insertion ratio 0% and the black insertion ratio 50% for a case in which gray-scale level correction is performed by using the gray-scale level correction data held by the gray-scale level correction data holding unit 14 and a case in which the gray-scale level correction is not performed.

The abscissa indicates the input gray-scale level and the ordinate indicates an absolute difference between the display gamma characteristic at the black insertion ratio 0% and the black insertion ratio 50%. A thin line indicates a graph in the case in which the gray-scale level correction is not performed and a bold line indicates a graph in the case in which the gray-scale level correction is performed. As shown in FIG. 5, when the correction is not performed, a difference occurs between display luminance of the liquid crystal display at the black insertion ratios 0% and 50% in input gray-scale levels lower than the 255 gray-scale level. On the other hand, when the correction is performed, the difference is 0 for all input gray-scale levels, i.e., the display gamma characteristics are the same regardless of the black insertion ratio. Therefore, a change in brightness of the liquid crystal display according to a change in the black insertion ratio does not occur.

(2) Method of adjusting a display gamma characteristic at the maximum black insertion ratio to a display gamma characteristic at the minimum black insertion ratio

According to Equation 3, a display gamma characteristic in the case that a black insertion ratio is the minimum (the minimum black insertion ratio 0%) is represented by Equation 6.

$${I}_{min} ( L ) = \frac{{( \frac{L}{255} )}^{γ} ( {T}_{max} ( 1 - {B}_{min} ) - {T}_{min} ) + {T}_{min}}{{T}_{max} ( 1 - {B}_{min} )} \qquad [ Equation 6 ]$$

where Iₘᵢₙ(L) indicates a relative luminance of the liquid crystal display of an L gray-scale level at the minimum black insertion ratio and Bₘᵢₙ indicates the minimum black insertion ratio. Therefore, a corrected gray-scale level for matching a display gamma characteristic at an arbitrary black insertion ratio B to a display gamma characteristic at the minimum black insertion ratio Bₘᵢₙ is represented as follows according to Equations 3 and 6.

$${L}_{c} ( L , B ) = 255 \cdot {( \frac{{I}_{min} ( L ) \cdot {T}_{max} ( 1 - B ) - {T}_{min}}{{T}_{max} ( 1 - B ) - {T}_{min}} )}^{1 / γ} \qquad [ Equation 7 ]$$

where L_{c}(L, B) represents a corrected gray-scale level in the case that an input gray-scale level is L and a black insertion ratio is B. In this embodiment, since the black insertion ratio is changed between 0% and 50%, a display gamma characteristic at the black insertion ratio 0% is set to Iₘᵢₙ(L) and a corrected gray-scale level at the black insertion ratio 50% is calculated by using Equation 7, whereby corrected gray-scale level data is obtained.

However, in Equation 7, a value of a numerator takes a negative value at a part of gray-scale levels L, i.e., a corrected gray-scale level L_{c} is undefined. This is because a display gamma characteristic at the minimum black insertion ratio takes a small value at the same input gray-scale level compared with a display gamma characteristic at the maximum black insertion ratio. Therefore, when an input gray-scale level is low, even if an input gray-scale level at the maximum black insertion ratio is corrected to the 0 gray-scale level, the input gray-scale level can only be corrected to a value larger than the display gamma characteristic at the minimum black insertion ratio. As a result, Equation 7 is corrected to Equation 8 below.

$${L}_{c} ( L , B ) = \{ \begin{matrix}\frac{{L}_{c} ( {L}_{th} , B )}{{L}_{th}} L & L < {L}_{th} \\ 255 \cdot {( \frac{{I}_{min} ( L ) \cdot {T}_{max} ( 1 - B ) - {T}_{min}}{{T}_{max} ( 1 - B ) - {T}_{min}} )}^{1 / γ} & \text{otherwise}\end{matrix} \qquad [ Equation 8 ]$$

Equation 8 indicates that, when an input gray-scale level is lower than an Lₜₕ gray-scale level (a threshold value), the input gray-scale level is corrected to a value on a straight line connecting a corrected gray-scale level at the Lₜₕ gray-scale level to the 0 gray-scale level. As a result, when an input gray-scale level L is lower than the Lₜₕ gray-scale level, it is impossible to match the display gamma characteristics at the minimum black insertion ratio and the maximum black insertion ratio. However, for input gray-scale levels equal to or higher than the Lₜₕ gray-scale level, it is possible to match the display gamma characteristics at the minimum black insertion ratio and the maximum black insertion ratio.

In this embodiment, the black insertion ratio is changed between 0% and 50%, a display gamma characteristic at the black insertion ratio 0% is set to Iₘᵢₙ(L) and a corrected gray-scale level at the black insertion ratio 50% is calculated by using Equation 8, whereby corrected gray-scale level data is obtained. This gray-scale level correction data is stored in the LUT of the gray-scale level correction data holding unit 14.

Since the minimum black insertion ratio (the black insertion ratio 0%) is set as a reference, a corrected gray-scale level at the minimum black insertion ratio (the black insertion ratio 0%) coincides with an input gray-scale level. Therefore, it is unnecessary to hold the correction data of both the minimum black insertion ratio (the black insertion ratio 0%) and the maximum black insertion ratio (the black insertion ratio 50%) in the LUT as shown in FIG. 3. The gray-scale level corrector 11 may detect whether a black insertion ratio is the minimum or the maximum and, when the black insertion ratio is the minimum, directly output the input gray-scale level as a corrected gray-scale level, and, only when the black insertion ratio is the maximum, calculate a corrected gray-scale level with reference to the gray-scale level correction data holding unit 14. In this case, a relation between the input gray-scale level at the maximum black insertion ratio and the corrected gray-scale level only has to be held in the LUT of the gray-scale level correction data holding unit 14.

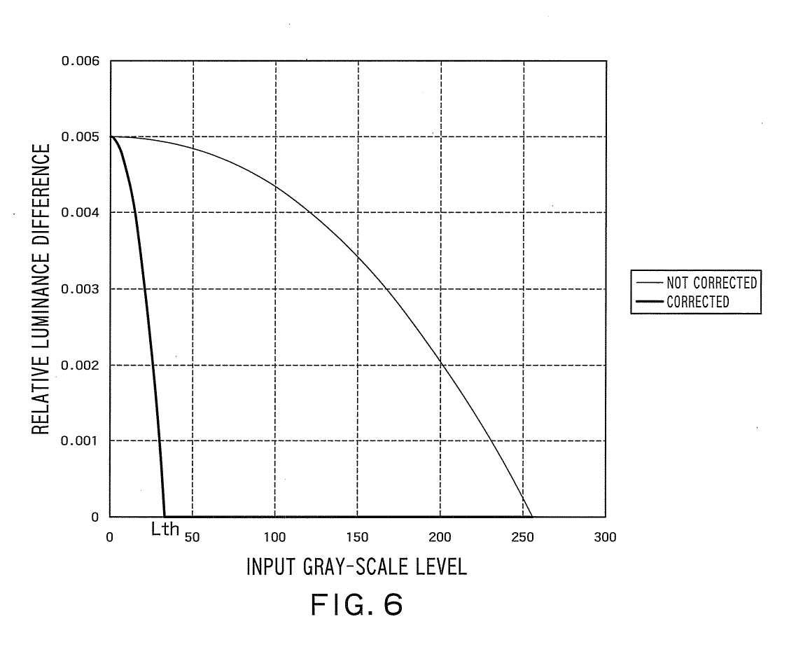

FIG. 6 shows a difference between a display gamma characteristic at the black insertion ratio 0% and the black insertion ratio 50% for a case in which gray-scale level correction is performed by using the gray-scale level correction data held by the gray-scale level correction data holding unit 14 and a case in which the gray-scale level correction is not performed.

The abscissa indicates the input gray-scale level and the ordinate indicates an absolute difference between the display gamma characteristic at the black insertion ratio 0% and the black insertion ratio 50%. A thin line indicates a graph in the case in which the gray-scale level correction is not performed and a bold line indicates a graph in the case in which the gray-scale level correction is performed. A threshold Lₜₕ is set to 32. As shown in FIG. 6, when the correction is not performed, a difference occurs between display luminance of the liquid crystal display at the black insertion ratios 0% and 50% in input gray-scale levels lower than the 255 gray-scale level. However, when the correction is performed, the difference is 0 at input gray-scale levels equal to or higher than the threshold Lₜₕ. At input gray-scale levels lower than the threshold Lₜₕ, the luminance difference is small compared with the case in which the correction is not performed. Therefore, the change in the display gamma characteristics due to the black insertion ratio is reduced. In other words, a change in brightness of the liquid crystal display according to a change in the black insertion ratio is substantially improved compared with the case in which the correction is not performed.

The gray-scale level correction data has been explained above. However, a method of calculating the gray-scale level correction data is not limited to the method of analytically calculating the gray-scale level correction data. For example, the gray-scale level correction data may be calculated by using actual measurement data. If a display gamma characteristic at the minimum black insertion ratio is matched to a display gamma characteristic at the maximum black insertion ratio, first, a backlight luminance is set such that a display luminance of the liquid crystal display at the minimum black insertion ratio and the maximum black insertion ratio coincide with each other at the maximum gray-scale level. Subsequently, a display gamma characteristic at the maximum black insertion ratio is measured and gray-scale level correction data at the minimum black insertion ratio is calculated to coincide with this display gamma characteristic at the maximum black insertion ratio.

The gray-scale level correction data does not have to be correction data for matching a display gamma characteristic at the minimum black insertion ratio and the maximum black insertion ratio. The gray-scale level correction data may be correction data (within a predetermined display luminance range) with which a difference between the display gamma characteristic at the minimum and the maximum black insertion ratios is small compared with that at the minimum and the maximum black insertion ratios in the case in which the correction is not performed. In other words, gray-scale level between the input gray-scale level and the corrected gray-scale level for matching the display gamma characteristic at the minimum and the maximum black insertion ratios may be set as corrected gray-scale level data. In this way, compared with the difference before the correction, it is possible to reduce the difference. Therefore, it is possible to reduce a change in brightness of the liquid crystal display according to a change in a black insertion ratio.

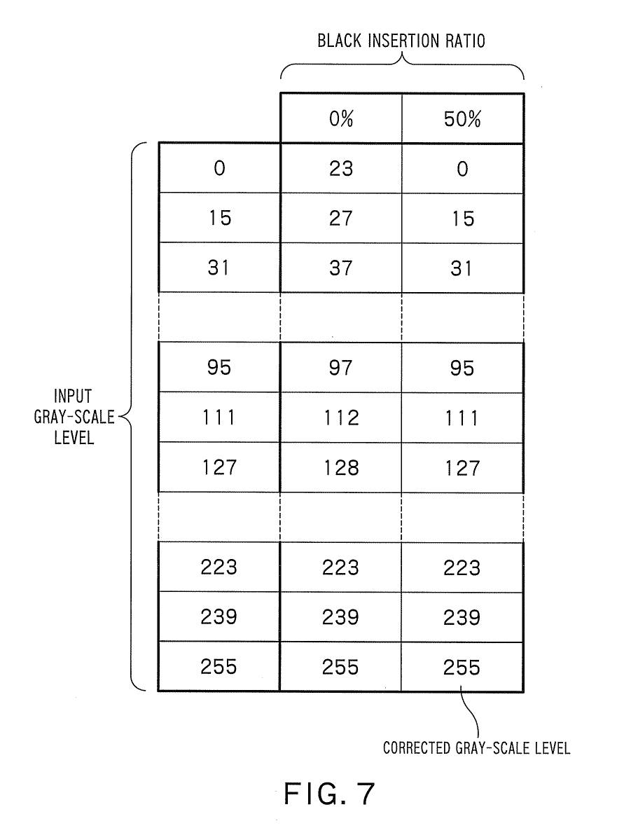

In FIG. 3, corrected gray-scale levels according to black insertion ratios are held in the LUT of the gray-scale level correction data for all input gray-scale levels. However, for example, as shown in FIG. 7, a corrected gray-scale level according to an input gray-scale level for each predetermined gray-scale levels and a black insertion ratio may be held. For an input gray-scale level between the predetermined gray-scale levels held in the LUT, a corrected gray-scale level only has to be calculated by appropriately interpolating the predetermined gray-scale levels. In the example in FIG. 7, if an input gray-scale level is 23 gray-scale level, linear interpolation only has to be performed in such a manner as (23-15)/(31-15)×(37-27)+27=32 gray-scale level.

### (Liquid Crystal Panel)

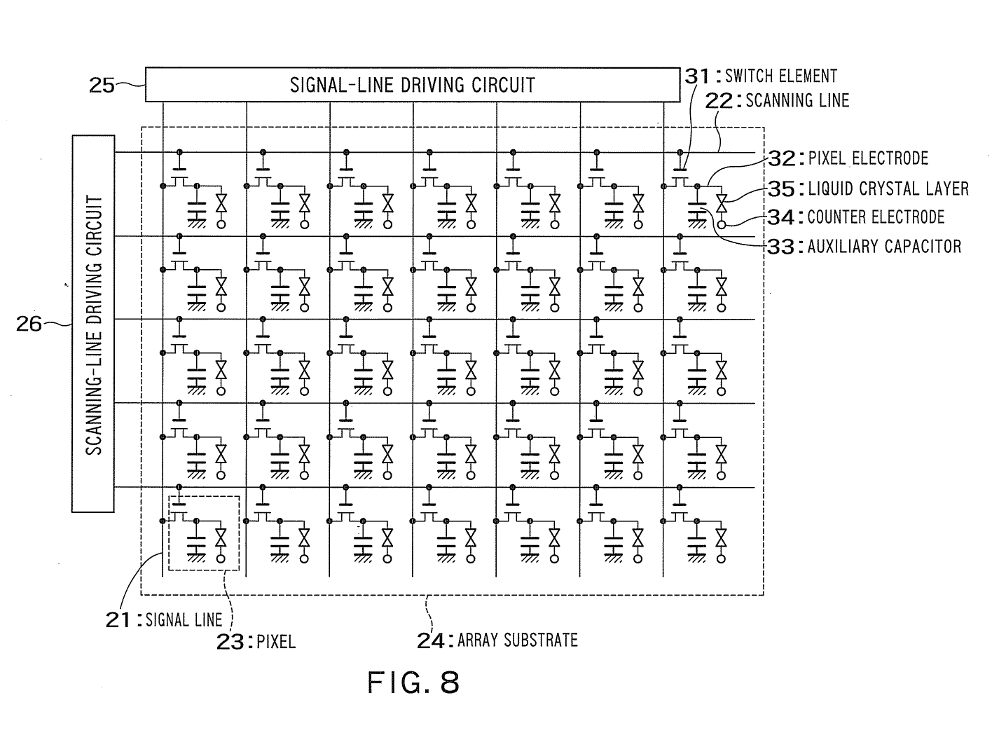

The liquid crystal panel 15 is a liquid crystal panel of an active matrix type in this embodiment. As shown in FIG. 8, plural signal lines 21 and plural scanning lines 22 crossing the signal lines 21 are arranged on an array substrate 24 via a not-shown insulating film. Pixels 23 are formed at respective intersections of both the lines. Ends of the signal lines 21 are connected to a signal-line driving circuit 25 and ends of the scanning lines 22 are connected to a scanning-line driving circuit 26.

In the pixels 23, switch elements 31 formed by thin film transistors (TFTs) are switch elements for writing a video signal. Gates of the switch elements 31 are connected to the scanning lines 22 in common for each horizontal line and sources thereof are connected to the signal lines 21 in common for each vertical line. Moreover, drains thereof are connected to pixel electrodes 32 and are connected to storage capacitors 33 electrically arranged in parallel to the pixel electrodes 32.

The pixel electrodes 32 are formed on the array substrate 24. Common electrodes 34 electrically opposed to the pixel electrodes 32 are formed on a not-shown opposed substrate. A predetermined common voltage is given to the common electrodes 34 from a not-shown common-voltage generating circuit. Liquid crystal layers 35 are held between the pixel electrodes 32 and the common electrodes 34. Peripheries of the array substrate 24 and the opposed substrate are sealed by a not-shown seal material. A liquid crystal material used for the liquid crystal layers 35 may be any material. However, as described later, since the liquid crystal panel 15 according to this embodiment needs to write two image signals for image display and black display in one frame period, it is desirable that the liquid crystal material responds at relatively high speed. For example, ferroelectric liquid crystal, liquid crystal of an OCB (Optically Compensated Bend) mode, and the like are preferable.

The scanning-line driving circuit 26 includes a not-shown shift register, level shifter, and buffer circuit. The scanning-line driving circuit 26 outputs a row selection signal to the respective scanning lines 22 on the basis of a vertical start signal and a vertical clock signal outputted from a gray-scale level corrector as control signals.

The signal-line driving circuit 25 includes a not-shown analog switch, shift register, sample hold circuit, and video bus. A horizontal start signal and a horizontal clock signal outputted from the gray-scale level corrector as control signals are inputted to the signal-line driving circuit 25. A video signal is also inputted to the signal-line driving circuit 25.

Operations of the liquid crystal panel 15 will be hereinafter explained in detail.

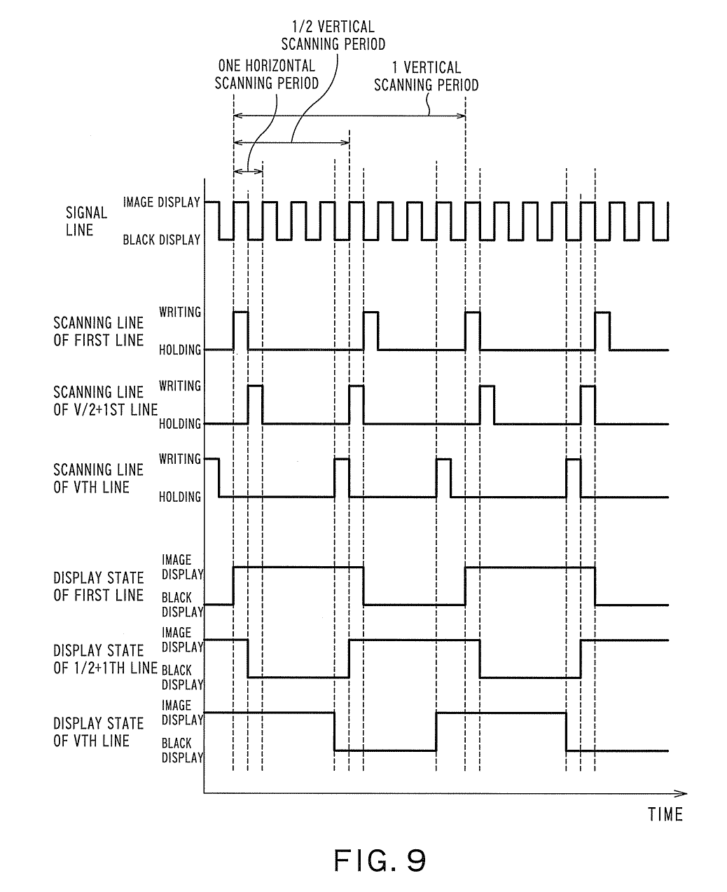

FIG. 9 shows a timing chart of the liquid crystal display panel 15 in the case in which a black display ratio is 50%. Driving waveforms of a display signal outputted from the signal-line driving circuit 25 and a scanning line signal outputted from the scanning-line driving circuit 26 and an image display state of the liquid crystal panel 15 are shown in the figure. In an example explained here, the number of vertical scanning lines is 8. In FIG. 9, for simplification of explanation, a blanking period is not shown. However, usually, a driving signal of a general liquid crystal panel has horizontal and vertical blanking periods.

The signal-line driving circuit 25 outputs an image display signal in a former half of one horizontal scanning period and outputs a black display signal in a latter half thereof. The scanning-line driving circuit 26 selects scanning lines corresponding to pixels, to which the image display signal should be supplied, in the former half of one horizontal scanning period and selects scanning lines corresponding to pixels, to which the black display signal should be supplied, in the latter half thereof.

When a scanning line of a first line is selected in the former half of on horizontal scanning period and the image display signal is supplied to pixels corresponding to the scanning line, a scanning line of a V/2+1th line is selected in the latter half of one horizontal scanning line and the black display signal is supplied to pixels corresponding to the scanning lines. Similarly, when a scanning line of a second line is selected in the former half of one horizontal scanning period, a scanning line of a V/2+2th line is selected in the latter half of one horizontal scanning period. Similarly, the next scanning lines are sequentially selected in the former half and the latter half of one horizontal scanning period. When a scanning line of a Vth line is selected in the former half of one horizontal scanning period and the image display signal is supplied to pixels corresponding to the scanning line, a scanning line of a V/2th line is selected in the latter half of one horizontal scanning period and the black display signal is supplied to pixels corresponding to the scanning line.

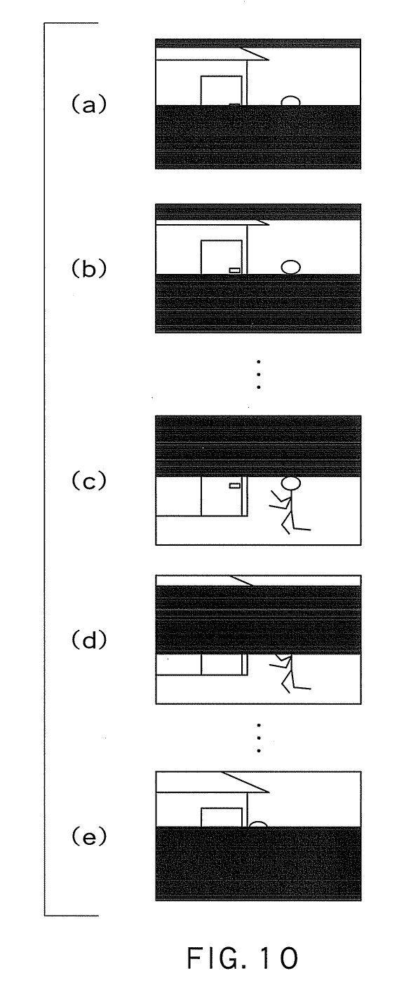

FIGS. 10(a) to (e) shows display states on the liquid crystal panel in the case in which a black insertion ratio is 50%. FIG. 10(a) shows a display state at the time when writing of an image display signal of an Nth frame is completed to a V/2+1th line and a black display signal is written in a first line. FIG. 10(b) shows a display state at the time when the image display signal of the Nth frame is written to a V/2+2th line and the black display signal is written in the second line. FIG. 10(c) shows a display state in which the image display signal of the Nth frame is written in a Vth line and the black display signal is written in a V/2−1th line. FIG. 10(d) shows a display state at the time when an image display signal of an N+1th frame is written in the first line and the black display signal is written in a V/2+1th line. FIG. 10(e) shows a display state at the time when the image display signal of the N+1th frame is written in a V/2th line and the black display signal is written in the Vth line.

In FIG. 9, the black insertion ratio is 50%. However, it is possible to set an arbitrary black insertion ratio by changing timing to start writing of the black display signal, i.e., changing the timing of a scanning line signal. Therefore, the black-insertion-ratio calculator 12 calculates a black insertion ratio and the gray-scale level corrector 11 sends the timing to start writing of the black display signal to the liquid crystal panel 15 as a control signal. This makes it possible to display an image on the liquid crystal panel 15 at the arbitrary black insertion ratio.

### (Backlight-Luminance Setting Unit)

The backlight-luminance setting unit 13 outputs a backlight luminance signal for setting a light source for the backlight 16 on the basis of the black insertion ratio. When a light source of the backlight 16 is an LED (Light-Emitting Diode) of analog modulation, the backlight-luminance setting unit 13 outputs an analog voltage signal. When the light source is an LED of a pulse width modulation (PWM), the backlight-luminance setting unit 13 outputs a pulse width modulation signal. When the light source is a cold cathode fluorescent lamp (CCFL), the backlight-luminance setting unit 13 outputs an analog voltage to be inputted to an inverter for lighting the CCFL.

In this embodiment, the LED light source of the pulse width modulation system is used. A relation between a pulse width inputted to the LED light source and luminance of a backlight is measured and stored in the backlight-luminance setting unit 13 in advance. As this holding data, for example, when it is possible to represent the relation with a function, the function may be held. The data may also be held in a ROM or the like as an LUT (Look-up Table). When LEDs with LED light sources of three primary colors of red, green and blue are mixed to display white, it is desirable to hold data of the respective LEDs.

The method of holding a relation between a pulse width and a backlight luminance as data is described above. However, a relation between a black insertion ratio and a pulse width with which luminance is constant on a liquid crystal panel displayed at various black insertion ratios may be held. A white image (a maximum gray-scale level) is displayed on the liquid crystal panel at a certain black insertion ratio, a backlight luminance is controlled to set luminance after transmission through the liquid crystal panel to a predetermined value, and a pulse width inputted to the LED light source at that time is obtained. The operation is performed at various black insertion ratios and relations between black insertion ratios and pulse widths are obtained and held as data. By referring to the data with a black insertion ratio, luminance of the backlight is controlled and it is possible to keep luminance on the liquid crystal panel constant with respect to an arbitrary black insertion ratio.

Other than the methods described above, a method of setting a photodiode or the like in a backlight, performing feedback while measuring luminance of the backlight with the photodiode or the like, and controlling luminance of an LED light source may be adopted. In particular, since a light emission characteristic of the LED light source changes according to temperature, it is effective to perform feedback with the photodiode or the like as described above.

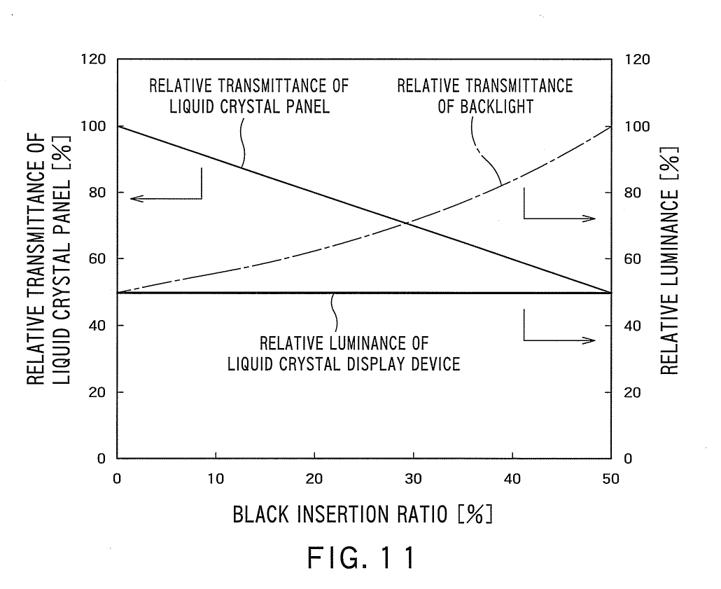

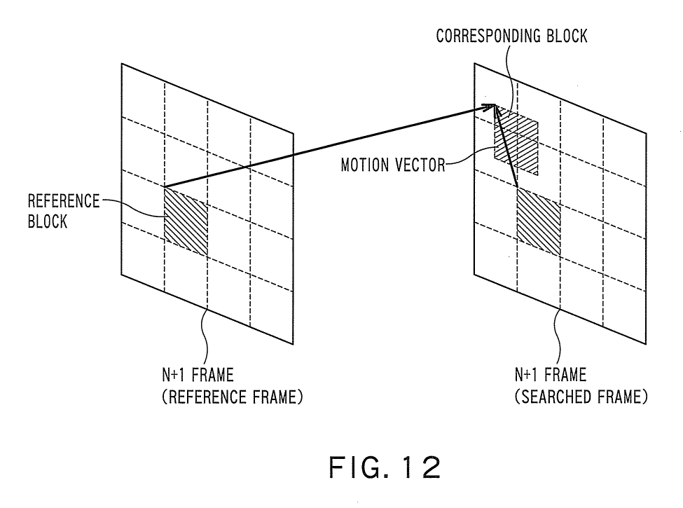

FIG. 11 is a diagram showing a relation among a black insertion ratio, a relative transmittance of a liquid crystal panel, a relative luminance of a backlight, and a relative luminance of the liquid crystal display at a setting of 0% to 50% of a black insertion ratio.

The abscissa indicates a black insertion ratio, the left ordinate indicates a relative transmittance with respect to the transmittance of the liquid crystal panel 15 at the time when the black insertion ratio is 0%, and the right ordinate indicates a relative luminance with respect to the luminance of the backlight 16 at the time when the black insertion ratio is 50%. In the liquid crystal panel 15 used in this embodiment, the transmittance linearly decreases as the black insertion ratio increases. Therefore, the luminance of the backlight is controlled to increase the luminance of the backlight 16 as the black insertion ratio increases, and thereby relative luminance of the liquid crystal display, i.e., the luminance after transmission through the liquid crystal panel is controlled to be constant. In other words, in FIG. 11, there is a relation of relative transmittance of the liquid crystal panel×relative luminance of the backlight=relative luminance of the liquid crystal display.

A relation between the black insertion ratio and the relative luminance of the backlight is calculated from FIG. 11. With the relation, it is possible to calculate a relation between the black insertion ratio and the pulse width from a relation between the relative luminance of the backlight and a pulse width inputted to the LED light source. Therefore, it is possible to calculate a backlight luminance setting signal represented by the pulse width from the black insertion ratio calculated by the black-insertion-ratio calculator 12.

### (Backlight)

As described above, it is possible to constitute the backlight 16 with various light sources. However, in this embodiment, the backlight 16 is a direct-type backlight with an LED as a light source. However, the structure of the backlight is not limited to the above. For example, the backlight may be an edge light type backlight employing a light guide plate. The luminance of the backlight is controlled by a backlight luminance setting signal outputted from the backlight-luminance setting unit 13.

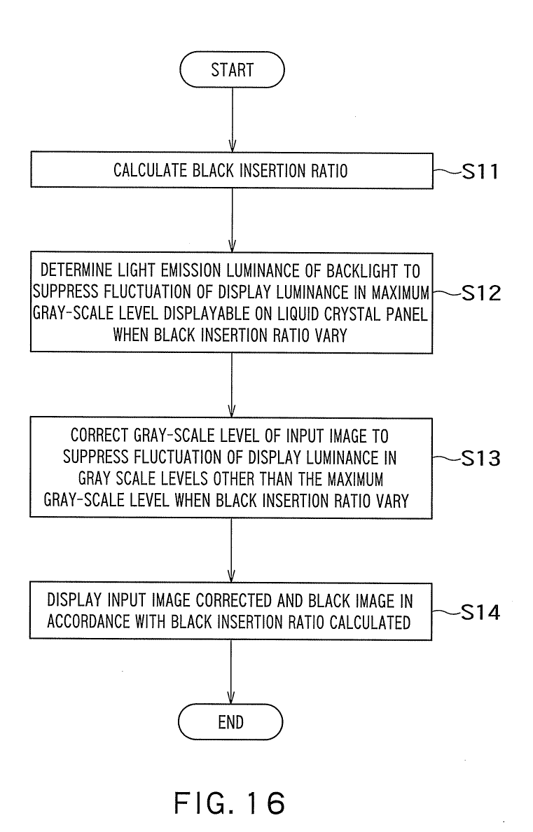

FIG. 16 is a flowchart for explaining an image display method executed in the liquid crystal display in FIG. 1.

First, a black insertion ratio representing a period in which a black image is displayed in one frame period is calculated (S11).

A light source luminance (light emission luminance) of the backlight is determined to suppress fluctuation of a display luminance in a maximum gray-scale level displayable on the liquid crystal panel when the black insertion ratio varies (S12).

Gray-scale levels of an input image are corrected to suppress fluctuation of display luminance in gray-scale levels other than the maximum gray-scale level when the black insertion ratio varies (S13).

The corrected input image and the black image are displayed in accordance with the calculated black insertion ratio (S14).

As described above, according to this embodiment, it is possible to improve a quality of a moving image displayed on the liquid crystal display by changing a black insertion ratio of the liquid crystal panel according to an input image. It is also possible to suppress a change in a display gamma characteristic due to a change in a black insertion ratio as much as possible.

### Second Embodiment

As a structure of a liquid crystal display according to a second embodiment of the invention, a basic structure is the same as that in the first embodiment. The liquid crystal display has a characteristic in that a black insertion ratio calculated by the black-insertion-rate calculator is calculated at plural steps rather than the two steps (0% and 50% in the first embodiment) as a result of detecting whether an input video is a moving image or a still image. Therefore, a structure of gray-scale level correction data held by the gray-scale level correction data holding unit is different from that in the first embodiment. A black-insertion-ratio calculator and a gray-scale level correction data holding unit, which are different from the first embodiment in this embodiment, are explained. Explanations of other components are omitted because the components are the same as those in the first embodiment.

### (Black-Insertion-Ratio Calculator)

The black-insertion-ratio calculator according to the first embodiment detects whether an input video is a moving image or a still image. Black insertion ratios at two steps are outputted to set a black insertion ratio to 50% in the case of a moving image and set a black insertion ratio to 0% when the input video is a still image. The black-insertion-ratio calculator according to this embodiment calculates black insertion ratios at plural steps, rather than the two steps described above. As a method of calculating black insertion ratios at plural steps, for example, as in the first embodiment, a sum of absolute difference between frames is calculated according to Equation 1 and a black insertion ratio is determined on the basis of a level of the sum of absolute difference. In this case, a black insertion ratio B is calculated by using threshold processing as shown in Equation 9.

$$B = \{ \begin{matrix}0 & SAD < {T}_{0} \\ 0.25 & {T}_{0} \leq SAD < {T}_{25} \\ 0.5 & SAD \geq {T}_{25}\end{matrix} \qquad [ Equation 9 ]$$

where SAD indicates a sum of absolute difference calculated by using Equation 1, T₀ and T₂₅ are thresholds with respect to the SAD (T₀<T₂₅). When the SAD is smaller than T₀, the black insertion ratio is set to 0%, when the SAD is equal to or larger than T₂₅, the black insertion ratio is set to 50%, and in other cases, the black insertion ratio is set to 25%. When the SAD is a small value, this means that a motion in an input video is small and contrast of a motion area is low. Therefore, even if the black insertion ratio is a small value, an effect of improvement of a moving image quality is sufficient. On the other hand, when the SAD is a large value, this means that a motion of an input video is large and contrast of a motion area is high. Therefore, the black insertion ratio is increased to improve a moving image quality.

In Equation 9, the black insertion ratios are set at the three steps. However, black insertion ratios at a larger number of steps are possible. For example, it is also possible to set a black insertion ratio as a continuous function based on the SAD and calculate a black insertion ratio as a continuous value in a predetermined black insertion ratio range (e.g., 0% to 50%). However, since the effect of improvement of a moving image quality is not increased even if the black insertion ratio is controlled excessively finely, it is preferable to calculate the black insertion ratio, for example, in steps of 1%.

In the above description, the method of calculating black insertion ratio at plural steps on the basis of a value of the SAD is explained. Besides, it is also possible that motion detection between two frames is performed and black insertion ratios at plural steps are calculated on the basis of a detected motion. The motion detection is performed by, for example, holding an input video in a frame memory for one frame period and using an image delayed by one frame and the input image, i.e., two frames temporally adjacent to each other. However, frames for detecting a motion are not limited to the temporally adjacent two frames. For example, when an input video is an interlaced video, the motion detection may be performed using only even fields or odd fields. Various means are conceivable as means for detecting motion. In this embodiment, a method of detecting a motion vector according to block matching is used. The block matching is a motion vector detection method used for encoding of moving image such as Moving Picture Experts Group (MPEG). As shown in FIG. 12, an Nth frame (a reference frame) of an input video is divided into square areas (blocks) and, for each of the blocks, a similar area in an N+1th frame (a searched frame) is searched for. As a method of evaluating the similar area, in general, a sum of absolute difference (SAD), a sum of squared difference (SSD), and the like are used. In this embodiment, the SAD is used and calculated according to Equation 10.

$${SAD}_{k} ( d ) = {\sum }_{x ∈ {B}_{k}} \vert p ( x , N ) - p ( x + d , N + 1 ) \vert \qquad [ Equation 10 ]$$

where p(x, N) represents a pixel value of a position x of the Nth frame and Bₖ represents an area of a kth reference block. The SAD is calculated for various values of d using Equation 10 and a value of d with which the SAD is minimized is estimated as a motion vector of the reference block Bₖ. This is represented by Equation 11.

$${MV}_{k} = \text{arg} {min}_{d} {SAD}_{k} ( d ) \qquad [ Equation 11 ]$$

By solving Equations 10 and 11 for all the blocks of the reference frame, it is possible to calculate a motion vector between adjacent frames of the input video. An average norm of motion vectors of the entire frame is calculated from the motion vector for each of the blocks. When the number of blocks is J, an average norm MVₐᵥₑ of motion vectors of the entire frame is calculated according to Equation 12.

$${MV}_{ave} = \frac{{\sum }_{k} ‖ {MV}_{k} ‖}{J} \qquad [ Equation 12 ]$$

In the same manner as the threshold processing applied to the SAD, threshold processing is applied to MVₐᵥₑ calculated as described above to calculate a black insertion ratio. It is also possible to set a black insertion ratio as a continuous function based on MVₐᵥₑ and calculate a black insertion ratio as a continuous value in a predetermined black insertion ratio range (e.g., 0% to 50%). In both the cases, a black insertion ratio is calculated such that a black insertion ratio takes a larger value as MVₐᵥₑ is larger.

### (Gray-Scale Level Correction Data Holding Unit)

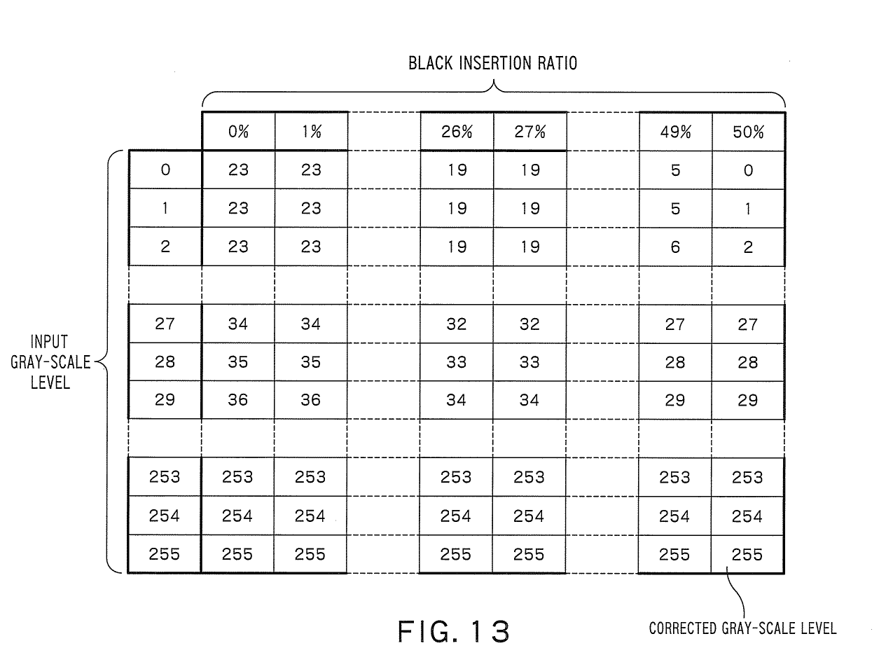

The gray-scale level correction data holding unit holds a relation between an input gray-scale level and a corrected gray-scale level for each of the black insertion ratios calculated by the black-insertion-ratio calculator as an LUT. For example, when a black insertion ratio is calculated by the black-insertion-ratio calculator in steps of 1%, as shown in FIG. 13, the gray-scale level correction data holding unit holds an LUT of a two-dimensional matrix structure in which black insertion ratios are held in a column direction and input gray-scale levels are held a row direction. By selecting a column according to a black insertion ratio and selecting a row according to an input gray-scale level, it is possible to acquire a corrected gray-scale level at an intersection of the column and the row.

The LUT does not have to be the two-dimensional matrix structure described above. The LUT may be any structure as long as it is possible to acquire a corrected gray-scale level according to a black insertion ratio and an input gray-scale level.

As a method of calculating gray-scale level correction data, there are three methods: a method of adjusting a display gamma characteristic at other black insertion ratios to a display gamma characteristic at the minimum black insertion ratio (the black insertion ratio 0%), a method of adjusting a display gamma characteristic at other black insertion ratios to a display gamma characteristic at the maximum black insertion ratio (the black insertion ratio 50%), and a method of adjusting a display gamma characteristic at other black insertion ratios to a display gamma characteristic at the reference black insertion ratio (e.g., the black insertion ratio 25%) set in advance between the minimum black insertion ratio (the black insertion ratio 0%) and the maximum black insertion ratio (the black insertion ratio 50%). The method of adjusting to a gamma characteristic at the maximum black insertion ratio and the method of adjusting to a gamma characteristic at the minimum black insertion ratio are the same as those in the first embodiment. Thus, the method of adjusting to a display gamma characteristic at the reference black insertion ratio will be explained.

A display gamma characteristic at the reference black insertion ratio is represented as follows by Equation 13

$${I}_{base} ( L ) = \frac{{( \frac{L}{255} )}^{γ} ( {T}_{max} ( 1 - {B}_{base} ) - {T}_{min} ) + {T}_{min}}{{T}_{max} ( 1 - {B}_{base} )} \qquad [ Equation 13 ]$$

where I_{base}(L) represents a display gamma characteristic at the reference black insertion ratio and B_{base} represents the reference black insertion ratio. A display gamma characteristic at an arbitrary black insertion ratio is matched to the display gamma characteristic at the reference black insertion ratio represented by Equation 13. When a black insertion ratio is lower than the reference black insertion ratio, processing same as the method of adjusting a display gamma characteristic at the minimum black insertion ratio to a display gamma characteristic at the maximum black insertion ratio in the first embodiment only has to be performed. When a black insertion ratio is equal to or higher than the reference black insertion ratio, processing same as the method of adjusting a display gamma characteristic at the maximum black insertion ratio to a display gamma characteristic at the minimum black insertion ratio in the first embodiment only has to be performed. A corrected gray-scale level is represented by Equation 14.

$${L}_{c} ( L , B ) = \{ \begin{matrix}\frac{{L}_{c} ( {L}_{th} , B )}{{L}_{th}} L & B \geq {B}_{base} ⋀ L < {L}_{th} \\ 255 \cdot {( \frac{{I}_{base} ( L ) \cdot {T}_{max} ( 1 - B ) - {T}_{min}}{{T}_{max} ( 1 - B ) - {T}_{min}} )}^{1 / γ} & \text{otherwise}\end{matrix} \qquad [ Equation 14 ]$$

where L_{c}(L, B) represents a corrected gray-scale level in the case that an input gray-scale level is L and a black insertion ratio is B. A threshold Lₜₕ may be a function depending on the black insertion ratio B rather than a constant. In particular, it is desirable that the threshold Lₜₕ and the black insertion ratio B are in a relation of Lₜₕ=0 in B=B_{base}. This is because it is possible to prevent a display gamma characteristic from discontinuously changing before and after B=B_{base}.

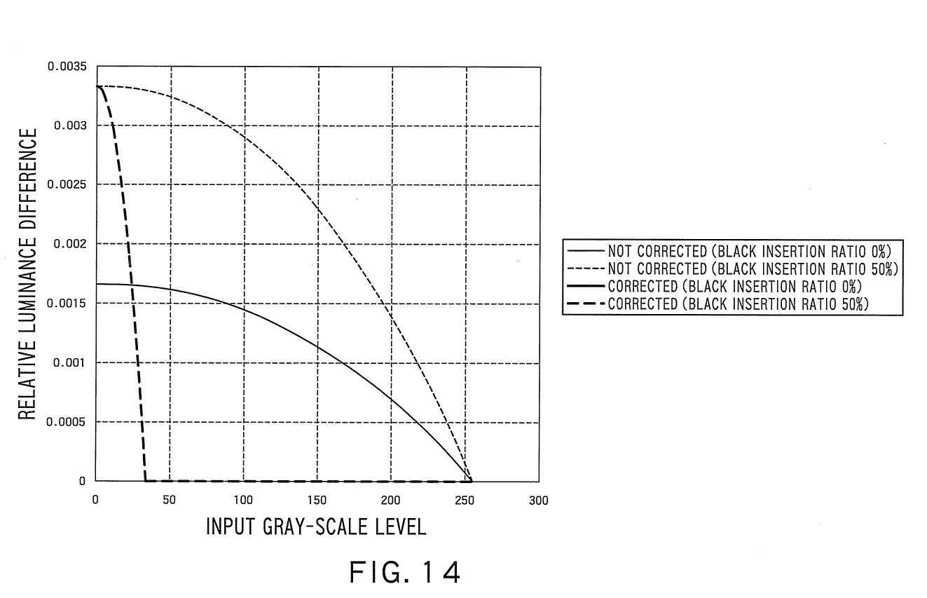

FIG. 14 shows a difference between display gamma characteristics at the minimum black insertion ratio 0% and the maximum black insertion ratio 50% due to presence or absence of correction of the input gray-scale level and a display gamma characteristic at the reference black insertion ratio 25%. The abscissa indicates an input gray-scale level and the ordinate indicates an absolute difference between a display gamma characteristic at the reference black insertion ratio 25% and display gamma characteristics at the minimum black insertion ratio 0% and the maximum black insertion ratio 50%. As it is evident from FIG. 14, by correcting gray-scale levels, it is possible to reduce a difference between the display gamma characteristic at the reference black insertion ratio and the display gamma characteristics at the minimum black insertion ratio (the black insertion ratio 0%) and the maximum black insertion ratio (the black insertion ratio 50%).

The gray-scale level correction data has been explained above. However, the method of calculating the gray-scale level correction data is not limited to the method of analytically calculating the gray-scale level correction data. For example, the gray-scale level correction data may be calculated on the basis of actual measurement data.

In order to match a display gamma characteristic at an arbitrary black insertion ratio to a display gamma characteristic at the reference black insertion ratio, first, a backlight luminance for each black insertion ratio is set such that a display luminance of the liquid crystal display at the arbitrary black insertion ratio coincides with that in the case of the reference black insertion ratio in the maximum gray-scale level. Subsequently, a display gamma characteristic at the reference black insertion ratio is measured and gray-scale level correction data at the arbitrary black insertion ratio is calculated to match with the display gamma characteristic at the reference black insertion ratio.

The gray-scale level correction data does not have to be correction data for matching a display gamma characteristic at the arbitrary black insertion ratio to a display gamma characteristic at the reference black insertion ratio. The gray-scale level correction data only has to be correction data with which a difference between the display gamma characteristic at the reference black insertion ratio and the display gamma characteristic at the arbitrary black insertion ratio is reduced (within a predetermined display luminance range) compared with that in the case in which correction is not performed. In other words, a gray-scale level between an input gray-scale level and a corrected gray-scale level for matching the display gamma characteristic at the reference and the other black insertion ratios may be set as corrected gray-scale level data. In this way, since it is also possible to at least reduce the difference compared with that before the correction, it is possible to reduce a change in brightness of the liquid crystal display according to a change in a black insertion ratio.

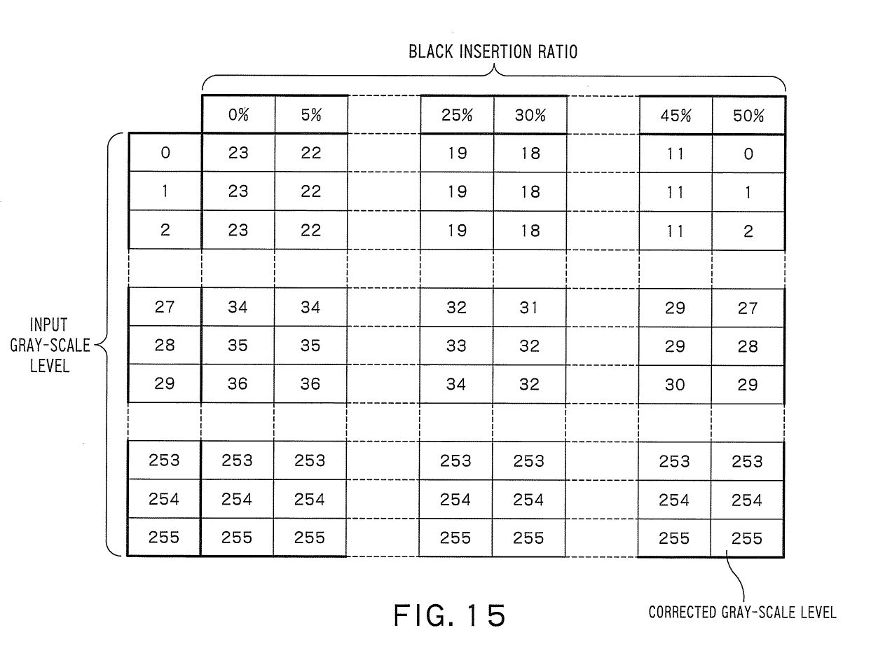

In FIG. 13, corrected gray-scale levels according to all input gray-scale levels and black insertion ratios at steps of 1% are held in the LUT of the gray-scale level correction data. However, for example, as shown in FIG. 15, a corrected gray-scale level and an input gray-scale level may be held per predetermined black insertion ratios. For a black insertion ratio between the predetermined black insertion ratios, a corrected gray-scale level only has to be calculated by appropriately interpolating the predetermined black insertion ratios. Moreover, as in the first embodiment, if a corrected gray-scale level is held per predetermined input gray-scale levels, it is possible to further reduce a size of the LUT.

As described above, according to this embodiment, it is possible to improve a quality of a moving image displayed on the liquid crystal display by changing a black insertion ratio of the liquid crystal panel according to an input video. It is also possible to suppress a change in a display gamma characteristic due to a change in a black insertion ratio as much as possible.

In the example explained in the embodiment, a black insertion ratio of the liquid crystal panel is changed according to an input video. However, a length of a period in which a black image should be displayed in one frame period of the input video may be changed instead of the black insertion ratio.

What is claimed is:

1. A liquid crystal display comprising:
an input unit configured to input an input image;
a light source configured to emit light;
a liquid crystal panel configured to display an image by modulating a transmittance or a reflectance of light from the light source based on signals representing the image;
a black information calculator configured to calculate black information indicating a length of a period in which black should be displayed in one frame period of the input image or a ratio of a period in which black should be displayed in the one frame period of the input image;
a light-source-luminance controller configured to control a light source luminance of the light source according to the black information to suppress fluctuation of a display luminance at a maximum gray-scale level displayable by the liquid crystal panel due to variation of a length of a black display period depending on the black information;
a gray-scale level corrector configured to correct a gray-scale level of each pixel of the input image to obtain corrected gray-scale levels to suppress fluctuation of a display luminance at gray-scale levels other than the maximum gray-scale level due to controlling of the light source luminance of the light source; and
a liquid crystal panel driver configured to, in the one frame period,
(1) provide the liquid crystal panel with signals of each pixel having the corrected gray-scale levels in continuous period obtained by subtracting a black display period depending on the black information from the one frame period, and
(2) provide the liquid crystal panel with signals of each pixel indicating black in the black display period.

2. The display according to claim 1, wherein
the black information calculator calculates a black insertion ratio in a range between a minimum black insertion ratio and a maximum black insertion ratio which are a minimum value and a maximum value of a ratio of a period in which the black image is displayed in the one frame period, and
the gray-scale level corrector corrects gray-scale levels of the input image to a gray-scale level which can obtain a display luminance within a predetermined display luminance range with respect to a display luminance at the time when the input image is displayed on the liquid crystal panel at a reference black insertion ratio which is in the range between the minimum black insertion ratio and the maximum black insertion ratio.

3. The display according to claim 2, wherein the predetermined display luminance range is a range between the display luminance at the time when the input image is displayed on the liquid crystal panel at the reference black insertion ratio and a display luminance at the time when the input image is displayed on the liquid crystal panel at the black insertion ratio calculated by the black information calculator.

4. The display according to claim 2, wherein
the reference black insertion ratio is the minimum black insertion ratio, and
the gray-scale level corrector corrects the gray-scale levels of the input image to lower gray-scale levels.

5. The display according to claim 2, wherein
the reference black insertion ratio is the maximum black insertion ratio, and
the gray-scale level corrector corrects the gray-scale levels of the input image to higher gray-scale levels.

6. The display according to claim 2, wherein the gray-scale level corrector corrects the gray-scale levels of the input image to higher gray-scale levels when calculated black insertion ratio is equal to or larger than the minimum black insertion ratio and smaller than the reference black insertion ratio, and corrects the gray-scale levels of the input image to lower gray-scale levels when the calculated black insertion ratio is larger than the reference black insertion ratio and equal to or smaller than the maximum black insertion ratio.

7. The display according to claim 1, further comprising a memory to hold a gray-scale level correction data representing a relation among black information, gray-scale levels, and corrected gray-scale levels, wherein
the gray-scale level corrector corrects the gray-scale levels of the input image by referring to the memory by using the black information of the input image and the gray-scale level of each pixel in the input image.

8. The display according to claim 7, wherein
the memory holds gray-scale levels at predetermined level intervals in the gray-scale level correction data, and
the gray-scale level corrector calculates a corrected gray-scale level by performing interpolation processing using a gray-scale level held in the memory lower than the gray-scale level of the input image and a gray-scale level held in the memory higher than the gray-scale level of the input image when the gray-scale level of the input image is not held in the gray-scale level correction data.

9. The display according to claim 7, wherein
the black information is a black insertion ratio representing a ratio of a period in which black image is displayed in one frame period,
the memory holds black insertion rations at predetermined intervals in the gray-scale level correction data, and
the gray-scale level corrector calculates a corrected gray-scale level by performing interpolation processing using data of a black insertion ratio held in the memory smaller than calculated black insertion ratio and data of a black insertion ratio held in the memory larger than the calculated black insertion ratio.

10. The display according to claim 1, wherein the gray-scale level corrector corrects the gray-scale level of the input image by calculating a function having black information and a gray-scale level as variables.

11. The display according to claim 1, wherein
the black information is a black insertion ratio representing a ratio of a period in which the black image is displayed in one frame period,
the black information calculator detects whether the input image is a still image or a moving image, calculates a first black insertion ratio as the black information when a result of detection is a still image, and, calculates a second black insertion ratio larger than the first black insertion ratio when a result of detection is a moving image.

12. The display according to claim 11, wherein the black information calculator calculates a sum of absolute difference between two frames of an input image and detects whether the input image is a still image or a moving image by comparing the sum of absolute difference with a threshold value.

13. The display according to claim 1, wherein
the black information is a black insertion ratio representing a ratio of a period in which the black image is displayed in one frame period, and
the black information calculator detects a magnitude of motion of an object in the input image and calculates a larger black insertion ratio as the magnitude of motion is larger.

14. The display according to claim 13, wherein the black information calculator detects a motion vector between two frames of an input image and determines the black insertion ratio based on a magnitude of detected motion vector.

15. The display according to claim 13, wherein the black information calculator calculates a sum of absolute difference between two frames of an input image and determines the black insertion ratio based on calculated sum of absolute difference.

16. An image display method for performing in an image display device including a light source capable of adjusting a light source luminance and a liquid crystal panel displaying an image by modulating a transmittance or a reflectance of light from the light source based on signals representing the image, comprising;
inputting an input image;
calculating black information indicating a length of a period in which a black image should be displayed in one frame period of an input image or a ratio of a period in which the black image should be displayed in the one frame period of the input image;
controlling a light source luminance of the light source according to the black information to suppress fluctuation of a display luminance at a maximum gray-scale level displayable by the liquid crystal panel due to variation of a length of a black display period depending on the black information;
correcting a gray-scale level of each pixel of the input image to obtain corrected gray-scale levels to suppress fluctuation of a display luminance at gray-scale levels other than the maximum gray-scale level due to the controlling of the light source luminance of the light source;
providing the liquid crystal panel with signals of each pixel having the corrected gray-scale levels in continuous period of a length obtained by subtracting a black display period of a length depending on the black information from the one frame period, and;
providing the liquid crystal panel with signals of each pixel indicating black in the black display period.
